(19) United States
(12) Patent Application Publication
(10) Pub. No.: US 2014/0032244 A1
(43) Pub. Date: Jan. 30, 2014

(54) SYSTEMS AND METHODS FOR TELEHEALTH DELIVERY AND ANALYSIS

(71) Applicant: Duke University, Durham, NC (US)

(72) Inventors: Bradley Kolls, Durham, NC (US); Julian P. Yang, Durham, NC (US); Daiwai Olson, Durham, NC (US)

(73) Assignee: Duke University, Durham, NC (US)

(21) Appl. No.: 13/951,439

(22) Filed: Jul. 25, 2013

Related U.S. Application Data
(60) Provisional application No. 61/675,531, filed on Jul. 25, 2012.

(51) Int. Cl. G06F 19/00

(52) U.S. Cl. CPC G06F 19/3418
USPC 705/3

(57) ABSTRACT

Systems and methods for telehealth delivery and analysis are disclosed. According to an aspect, a method includes receiving medical data associated with a patient. Further, the method includes determining consultation communication data associated with one or more communications between a healthcare professional and the patient. The method also includes generating statistical analysis data based on the medical data and the consultation communication data.

### CROSS REFERENCE TO RELATED APPLICATION

This application claims the benefit of U.S. Provisional Patent Application No. 61/675,531, filed Jul. 25, 2012 and titled SYSTEMS AND METHODS FOR TELEHEALTH DELIVERY, the disclosure of which is incorporated herein by reference in its entirety.

### TECHNICAL FIELD

The present subject matter relates to healthcare. More particularly, the present subject matter relates to telehealth delivery and analysis.

### BACKGROUND

Despite being a leading cause of both death and disability in the United States, stroke continues to be an under-recognized and under-treated diagnosis in the emergent setting. Treatment rates of ischemic stroke with intravenous recombinant tissue plasminogen activator (r-tPA) continue to be low in the United States with only 3-8% of ischemic stroke patients receiving treatment. Nearly two thirds of U.S. hospitals do not offer r-tPA treatment at all with a trend for smaller hospital size and rural location being associated factors for non-treatment. It is estimated that only half the U.S. population resides within timely access (<60 minutes) to a primary stroke center.

In recent years, the emergence of telestroke—systems of care employing high-quality, two-way, audio-video technology—has been seen as a potential solution to bridge the gap between stroke centers and underserved populations. The feasibility and the efficacy of telestroke systems has now been established around the world.

With the ongoing adaptation of telestroke systems, there is a growing consensus among stroke specialists regarding minimum hardware requirements. However, little attention has been paid to the data that is a product of software used to manage work flow, clinical information, and documentation during the telestroke encounter. The electronic capture and storage of this data may greatly aid in describing the metrics of telestroke care.

Minimal data exists to describe the time commitment required by specialists involved with telestroke consultation. There is also little information in regards to how quickly these physician users can respond to acute stroke care via telestroke in real world settings. These times may have implications on best practice standards of treating ischemic stroke patients with r-tPA as quickly as possible.

For at least the foregoing reasons, it is desired to provide improvements with respect to telehealth.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for telehealth delivery and analysis. According to an aspect, a method includes receiving medical data associated with a patient. Further, the method includes determining consultation communication data associated with one or more communications between a healthcare professional and the patient. The method also includes generating statistical analysis data based on the medical data and the consultation communication data.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a schematic diagram of a system for telehealth delivery and analysis in accordance with embodiments of the present subject matter; and

FIG. 2 is a flow chart of an example method for telehealth delivery and analysis in accordance with embodiments of the present subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Articles “a” and “an” are used herein to refer to one or to more than one (i.e. at least one) of the grammatical object of the article. By way of example, “an element” means at least one element and can include more than one element.

Unless otherwise defined, all technical terms used herein have the same meaning as commonly understood by one of ordinary skill in the art to which this disclosure belongs.

Telehealth may refer to the delivery of health-related services and information via telecommunications technologies. Telehealth may include communications between healthcare professionals or communications between a healthcare professional and a patient. Telehealth communications may be implemented via email exchange, a web service, a telephone call, text messaging, or the like. Communications may be implemented over any suitable network, such as the Internet or a mobile network. An example end computing device for use by a healthcare professional or a patient may include, but is not limited to, a computer, a smartphone. In another example, the end computing device can be a medical device such as a network compatible medical device (e.g., home blood pressure monitor or glucometer).

As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD™ device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, a “user interface” is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, a user interface can be a display window or display object, which is selectable by a user of a mobile device for interaction. The display object can be displayed on a display screen of a mobile device and can be selected by, and interacted with by, a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the presently disclosed subject matter may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the presently disclosed subject matter may be implemented in other and next-generation mobile networks and devices as well. The mobile device is the physical equipment used by the end user, typically a subscriber to the wireless network. Typically, a mobile device is a 2.5G-compliant device or 3G-compliant device (or the proposed 4G-compliant device) that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The mobile device may also include a memory or data store.

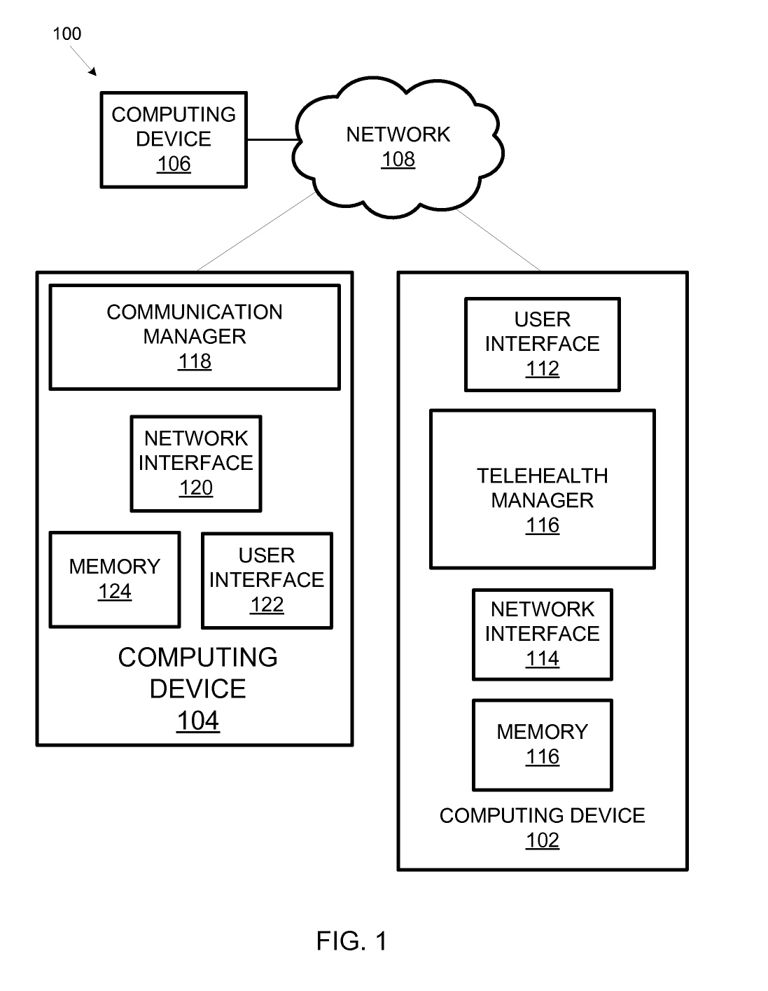

The presently disclosed subject matter is now described in more detail. For example, FIG. 1 is a schematic diagram of a system 100 for telehealth delivery and analysis in accordance with embodiments of the present subject matter. Referring to FIG. 1, the system 100 includes a computing device 102. In this example, the computing device 102 may be a web server configured to communicate within one or more computing devices, such as computing devices 104 and 106, via a suitable network 108. Only two computing devices are shown in FIG. 1 for simplicity of illustration, although it should be understood that any number of computing devices may be communicatively connected to the network 108 for communication to the computing device 102. It is also noted that the operation of the computing device 102 described in this example may alternatively be implemented in another computing device or in multiple other computing devices.

The computing device 102 may include a telehealth manager 110 configured to implement functions in accordance with embodiments of the present subject matter. Particularly, for example, the telehealth manager 110 may be configured to receive medical data associated with a patient, to determine consultation communication data associated with one or more communications between a healthcare professional and the patient, and to generate statistical analysis data based on the medical data and the consultation communication data. The telehealth manager 100 may be implemented by hardware, software, firmware, the like, or combinations thereof. For example, the telehealth manager 116 may include one or more processors and memory. The computing device 102 may include a user interface 112, network interface 114, and memory 116.

The computing device 104 is provided for depicting an example of a device for use by a patient. The computing device 104 may include a communication manager 118 may be configured to manage a network interface 120 and user interface 122 for communicating with the computing device 102 in accordance with embodiments of the present subject matter. The communication manager 118 may be implemented by hardware, software, firmware, the like, or combinations thereof. For example, the communication manager 118 may include one or more processors and memory. The computing device 102 may include a memory 124.

The computing devices 102 and 104 may communicate with one another via a network 108. For example, the devices may communicate via email exchange, a web service, a telephone call, text messaging, or the like. The network 108 may be, for example, the Internet.

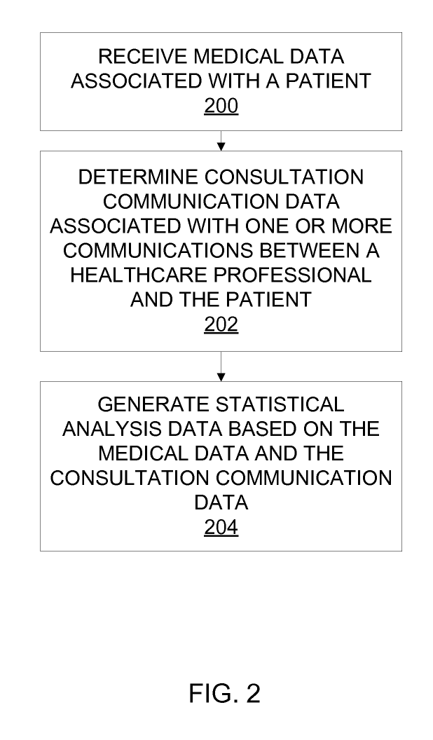

FIG. 2 illustrates a flow chart of an example method for telehealth delivery and analysis in accordance with embodiments of the present subject matter. In this example, reference is made to the system 100 shown in FIG. 1, although it is noted that the method may be implemented in any other suitable system.

Referring to FIG. 2, the method includes receiving 200 medical data associated with a patient. For example, the telehealth manager 116 of the computing device shown in FIG. 1 may receive medical data associated with a patient. The patient data may include one or more of an age, diagnosis, time of arrival from symptom onset, neurological examination finding, r-tPA contraindication, and absence of vascular risk factors of the patient, and the like. Further, the data may include, for example, indication of a presence of one or more of diabetes, hypertension, prior stroke, atrial fibrillation, vascular disease, and the like. Further, for example, the data can include medical data of the patient logged subsequent to the patient being discharged from a medical facility. The data may be obtained locally from the memory 116 and/or obtained remotely from another memory via the network 108. The telehealth manager 116 may obtain the data.

The method of FIG. 2 includes determining 202 consultation communication data associated with one or more communications between a healthcare professional and the patient. Continuing the aforementioned example, consultation communication data may include one or more of a time length of consultation and a consultation response time. The telehealth manager 116 may make this determination. Consultation communication data may be the data exchanged between computing devices 102 and 104 during consultation between a patient and healthcare professional. This data may be, for example, stored in the computing device 106, which may be a web server configured to store the data locally or remotely. The telehealth manager 116 may be configured to control access to obtain the stored data via the network 108.

The method of FIG. 2 includes generating 204 statistical analysis data based on the medical data and the consultation communication data. Continuing the aforementioned example, the statistical analysis data may be determined by the telehealth manager 116. Examples of statistical analysis data may include but are not limited to, average duration of consults, average latency to respond, average number of encounters for a given user/computer/location, number of times tpa was given for the current situation. Such data may be presented to a user, such as a healthcare professional, at the computing device 102 via the user interface 112.

In accordance with embodiments, the present disclosure describes, in part, the length of time physicians spend completing telestroke consultations and examine factors associated with that time period. It is noted that studies disclosed herein show, in part, a retrospective review of data from telestroke software. In these studies, demographics and clinical data obtained from eight “hub” and 24 “spoke” hospitals were abstracted for 235 consecutive consultations and linked to time metadata generated by clinician interaction with the software. Consult length was defined as time logged on to the robot and was exclusive of any telephone interaction or documentation time. Response time was defined as patient arrival to physician log-on.

Results show that the mean consult length for 203 complete, time-stamped cases was 14.5 minutes (IQR 9.2-18.4). Among these cases, there was no independent association between consult length and age, diagnosis, time of arrival from symptom onset, neurological exam findings, known r-tPA contraindications, and absence of vascular risk factors. Mean consult length was statistically longer in r-tPA-recommended cases (20.0 vs 15.3 minutes; p=0.04). Mean response time was 76.3 minutes (IQR 39.4-94.0) with a non-significant trend (p=0.82) towards longer times (91.9 minutes) at night from 12:01 am to 6:00 am.

The relatively short consult time supports a model in which a stroke work-up is largely completed prior to telestroke consultation. In this model, the benefit of telestroke is to have a specialist efficiently render an expert opinion on a gathered set of data. The findings for mean response time indicate an area for improvement in telestroke care. These findings may be validated, but this initial experience identifies key issues that can be addressed in the design of other telestroke studies: standardization of care models, careful documentation of offline work, and thoughtful software design based on the common use case. A further understanding can be obtained by reference to certain specific examples set forth below, which are provided herein for purposes of illustration only, and are not intended to be limiting unless otherwise specified.

### EXAMPLES

### I. Targeting Telestroke: Initial Attempt to Benchmark Time Performance in Telestroke Consultations.

In an example method, a retrospective analysis of demographic and clinical data of telestroke encounters captured electronically in StrokeRESPOND® documentation software (available from InTouch Technologies, Inc., Santa Barbara, Calif.) correlated with metadata generated from data logs recording time points at which physicians interacted with both this software and hardware endpoints (i.e. telestroke robots). From 8 hub and 24 spoke hospitals, there were 235 distinct, consecutive telestroke encounters. These encounters were cross-referenced with cases in which data logs from both StrokeRESPOND® and hardware endpoints were available. Cases in which patient arrival times were not charted were excluded (n=11). Additionally, cases in which charted arrival times conflicted logically with available metadata were excluded (e.g. arrival times charted after telestroke consultation initiation, n=21).

After exclusion, there were 203 telestroke encounters with complete, time-stamped data logs encompassing 14 physician users. Demographic data electronically abstracted from StrokeRESPOND® included age, gender, weight, and the presence of diabetes, hypertension, prior stroke, atrial fibrillation or flutter, and/or other vascular disease. Other information collected about telestroke encounters included presence of normal or baseline exam, final consultation diagnosis, administration of r-tPA, and patient disposition.

“Response time” was defined as the length of time between patient arrival in spoke hospital and physician user log-on to the robot. Timing of any telephone interaction between spoke hospital emergency department personnel and hub hospital physician was not consistently documented and unavailable for analysis. “Consult length” was defined strictly as the time a physician user was logged on to the robot. This definition was exclusive of any telephone interaction or documentation time that occurred either before or after the telestroke consultation.

Statistical analysis relating clinical variables' effect on mean times was performed with ANOVA and paired t-test using SAS-JMP and SASv9.4 software.

This sample had 85 males and 111 females; mean age was 69.3 years (s.d. 15.9). The majority of patients had at least one vascular risk factor (158 patients, 77.8%). Of note, 63 patients (31.0%) were known to have history of a stroke prior to telestroke consultation. More details are provided in Table 1 below.

TABLE 1
Patient Demographics

| Variable | N = xxx (%) |
|---|---|
| Age | Mean |
| | 69.3 +/− 15.9 years |
| Male* | 85 (41.9%) |
| Diabetes | 58 (28.6%) |
| Hypertension | 74 (36.5%) |
| Prior stroke or TIA | 63 (31.0%) |
| Atrial fibrillation or flutter | 22 (10.8%) |
| Other vascular disease | 27 (13.3%) |

*Gender not recorded in 7 cases.

Categories of consultation diagnoses included ischemic stroke or transient ischemic attack (TIA) (60/203, 29.6%), hemorrhagic stroke (6/203, 2.9%), psychiatric illness (3/203, 1.5%), other medical illness (6/203, 2.9%), and undiagnosed neurological symptoms (77/203, 37.9%). In this sample, there were no documented diagnoses of seizure or other specified neurological disease (e.g. brain tumor). In the cases of ischemic stroke or TIA, the administration of intravenous r-tPA was recommended in 13 cases (13/60, 21.7%). Reasons for not recommending r-tPA were inconsistently recorded. A final diagnosis at the end of the telestroke consultation was not recorded in 51 cases.

Mean response time was 76.3 min (IQR 39.4-94.0) in this sample. Most telestroke consultations occurred during daytime hours, but in 9 cases, patients arrived to emergency department at night in between the hours of 12:01 am to 6:00 am. Although mean response times were longer at night (91.9 minutes), this difference was not significant (p=0.82).

Mean consult length for the entire cohort was 14.5 minutes (IQR 9.2-18.4). Mean consult length was significantly longer in cases in which r-tPA was recommended (20.0 vs. 15.3 minutes, p=0.04). Additional details are provided in Table 2 below. There was no independent association between consult length and multiple clinical variables, including age, time of arrival from symptom onset, absence of vascular risk factors, and consultation diagnosis. Factors thought to favor shorter consultation times, such as normal or baseline neurological exam or presence of r-tPA contraindications, were also not independently associated.

TABLE 2
Mean Consult Length by Clinical Variables

| Variable | | | p-value |
|---|---|---|---|
| Age | Age ≦ 55 (n = 39) | Age > 55 (n = 160) | |
| | 15.4 min | 14.3 min | 0.43 |
| | Age ≧ 80 (n = 66) | Age < 80 (n = 133) | |
| | 13.4 min | 15.1 min | 0.13 |
| Arrival Time | ≦4.5 Hours (n = 79) | >4.5 Hours (n = 110) | |
| | 15.0 min | 14.1 min | 0.44 |
| Neurological | Normal/Baseline | New Symptoms | |
| Exam | (n = 23) | (n = 137) | |
| | 15.6 min | 14.8 min | 0.65 |
| tPA Contra- | Absent (n = 61) | Present (n = 142) | |
| indications | 14.7 min | 14.4 min | 0.77 |
| Vascular Risk | Absent (n = 45) | Present (n = 158) | |
| Factors | 13.5 min | 14.8 min | 0.33 |
| tPA | Yes (n = 13) | No (n = 115) | |
| Recommended | 20.0 min | 15.3 min | 0.04 |

Recommendation for disposition was documented in 67 cases. Transfer of care to hub hospital was recommended for 52.2 (35/67 cases). In this group, transfer rates varied by diagnosis: ischemic stroke or TIA (15/20, 75%), hemorrhagic stroke (3/3, 100%), psychiatric illness (0/1, 0%), other medical illness (0/1, 0%), undiagnosed neurological symptoms (11/25, 44%), and missing (6/17, 35.3%). In this group, all 4 cases in which r-tPA administration was recorded and recommended were also recommended to transfer care. Tables 3 and 4 below show Mean Response Time by Arrival Time and Recommendation for Transfer by Consultation Diagnosis, respectively.

TABLE 3
Mean Response Time by Arrival Times

| Time of Patient | | Mean Response Time | |
|---|---|---|---|
| Arrival | Number of Cases | (minutes) | p-value |
| 0601-1200 | 80 | 74.6 | 0.82* |
| 1201-1800 | 84 | 77.0 | |
| 1801-0000 | 30 | 74.2 | |
| 0001-0600 | 09 | 91.9 | |
| TOTAL | 203 | 76.3 | |

*Omnibus test of means.

TABLE 4
Recommendation for Transfer by Consultation Diagnosis

| Diagnosis | No Transfer | Transfer |
|---|---|---|
| Ischemic Stroke or TIA | 5 | 15 |
| Hemorrhagic Stroke | 0 | 3 |
| Undiagnosed Neurological Symptoms | 14 | 11 |
| Psychiatric Illness | 1 | 0 |
| Other Medical Illness | 1 | 0 |
| Missing Diagnosis | 11 | 6 |
| TOTAL | 32 | 35 |

This study describes telestroke quality of care in terms of temporal parameters obtained directly from telestroke network data. The American Stroke Association's “TARGET:Stroke” initiative with its goal of door-to-needle times of ≦60 minutes may serve as frame of reference for judging the timeliness of telestroke. The administration of intravenous r-tPA was recommended in a relatively few cases in this study, but the times found for consult length and response time may indicate how well telestroke might perform in the quick delivery in r-tPA.

The mean consult length of 14.5 minutes suggests that telestroke consultations are quick and efficient; however, it is important to note that this figure solely represents the time logged by a physician user directly interacting with hardware endpoints and was exclusive of any undocumented time spent communicating over telephone prior to or after telestroke consultation. Physician time for documentation itself was also unaccounted for.

Consult length, found to be consistent across multiple independent clinical variables, is relatively brief in relation to a 60-minute goal for completion of acute stroke protocols. This finding has two important implications about the use of telestroke in real-world settings. First, the use of telestroke technology (i.e. managing a patient encounter via a robot interface) does not appear to be overly cumbersome for physician users. Previous published studies have documented software problems and physician difficulty with technical troubleshooting that limited the efficacy of telestroke consultations.⁹ The group in this study, however, benefitted from using a standardized telestroke platform with software and hardware endpoints integrated with a network managed by a third-party for connectivity and technical issues (SureCONNECT® software available from InTouch Technologies, Inc.).

Second, the relatively brief consult lengths suggests that the workflow model for managing acute stroke via telestroke systems may be very different from live encounters in person. In our interpretation, physician users do not appear to be utilizing telestroke technology to manage stroke codes from start to finish in entirety. Rather, after a patient's arrival in the emergency department of a spoke hospital, much of the initial triage and work-up, including neuro-imaging, likely is conducted offline prior to telestroke consultation. Upon completion of this work up, stroke specialists are then called in via telestroke to review already collected clinical information, perform a confirmatory neurological examination, and then render an expert opinion regarding appropriate management and disposition. The recommendation for administration of r-tPA was the only statistically significant variable associated with longer consult times (20.0 minutes), which possibly represent time needed to re-check exam findings or instruct spoke-site staff about drug dosing and delivery.

This is a postulated model of care, with stroke specialists functioning in a more interpretive and confirmatory capacity. Further study of telestroke is required to support this model. If the model holds, it should drive further design and planning of future telestroke software, clinical protocols, and research. Additionally, any proposed schema for specialist reimbursement for tele consultation should avoid traditional, time-based billing structures to ensure fair compensation for clinical encounters of high acuity, complexity, and liability.

The mean response time of 76.3 minutes and its considerable range (IQR 39.4-94.0) in this group clearly indicate an area for improvement. Even in a model of care in which response time may correspond to productive, offline work being performed at the spoke hospital prior to telestroke consultations, the protracted figures in this study do not support achievement of adequate door-to-needle times less than 60 minutes. They highlight a recurring theme of successful telestroke systems: the necessity of education and continual re-education of personnel at spoke sites regarding clinical protocols and best practice standards. The implementation of telestroke systems should require not only the installation of high-quality technological platforms but also the rigorous training for all personnel involved to gain familiarity with how to optimize patient care.

Recent attention to “off-hour admissions” has shown variable outcome differences for stroke patients. The small sample in this study did not show a statistically significant trend; however, the 9 cases arriving in early morning hours (12:01 am to 6:00 am) did have longer mean response times. The reasons for longer response times are not documented, but future studies could be directed towards collecting information about physician user practices, including variables such as call structure and contact methods.

The presently disclosed subject matter provides systems and techniques for examining telestroke and other telehealth metrics and to explore what clinical variables and other non-random factors may be associated with either shorter or longer healthcare consultation times.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a processor and memory:
receiving medical data associated with a patient;
determining consultation communication data associated with one or more communications between a healthcare professional and the patient; and
generating statistical analysis data based on the medical data and the consultation communication data.

2. The method of claim 1, wherein receiving medical data comprises receiving medical data of the patient logged subsequent to the patient being discharged from a medical facility.

3. The method of claim 2, wherein receiving medical data comprises receiving data indicating a presence of one of a medical condition, diabetes, hypertension, prior stroke, atrial fibrillation, and vascular disease.

4. The method of claim 2, wherein receiving medical data comprises receiving one of an age, diagnosis, time of arrival from symptom onset, neurological examination finding, r-tPA contraindication, and absence of vascular risk factors of the patient.

5. The method of claim 1, wherein determining consultation communication data comprises one of a time length of consultation and a consultation response time.

6. The method of claim 1, wherein generating statistical analysis data comprises determining a relation between the medical data and the consultation communication data.

7. A system comprising:
at least a processor and memory configured to:
receive medical data associated with a patient;
determine consultation communication data associated with one or more communications between a healthcare professional and the patient; and
generate statistical analysis data based on the medical data and the consultation communication data.

8. The system of claim 7, wherein the at least a processor and memory are configured to receive medical data of the patient logged subsequent to the patient being discharged from a medical facility.

9. The system of claim 8, wherein the at least a processor and memory are configured to receive data indicating a presence of one of a medical condition, diabetes, hypertension, prior stroke, atrial fibrillation, and vascular disease.

10. The system of claim 8, wherein the at least a processor and memory are configured to receive one of an age, diagnosis, time of arrival from symptom onset, neurological examination finding, r-tPA contraindication, and absence of vascular risk factors of the patient.

11. The system of claim 7, wherein the at least a processor and memory are configured to determine one of a time length of consultation and a consultation response time.

12. The system of claim 7, wherein the at least a processor and memory are configured to determine a relation between the medical data and the consultation communication data.

13. A computer program product for telehealth delivery and analysis, said computer program product comprising:
a computer readable storage medium having computer readable program code embodied therewith, the computer readable program code comprising:
computer readable program code configured to receive medical data associated with a patient;
computer readable program code configured to determine consultation communication data associated with one or more communications between a healthcare professional and the patient; and
computer readable program code configured to generate statistical analysis data based on the medical data and the consultation communication data.

14. The computer program product of claim 13, further comprising computer readable program code configured to receive medical data of the patient logged subsequent to the patient being discharged from a medical facility.

15. The computer program product of claim 14, wherein the medical data indicates a presence of one of a medical condition, diabetes, hypertension, prior stroke, atrial fibrillation, and vascular disease.

16. The computer program product of claim 14, wherein the medical data indicates one of an age, diagnosis, time of arrival from symptom onset, neurological examination finding, r-tPA contraindication, and absence of vascular risk factors of the patient.

17. The computer program product of claim 13, wherein the consultation communication data comprises one of a time length of consultation and a consultation response time.

18. The computer program product of claim 13, computer program product determine a relation between the medical data and the consultation communication data.
